(19) United States
(12) Patent Application Publication
(10) Pub. No.: US 2008/0194417 A1
(43) Pub. Date: Aug. 14, 2008

(54) Method for Measuring and Comparing the Activity of Biologically Active Compounds

(76) Inventors: Luca Barella, Basel (CH); Patrick Y. Muller, Allschwil (CH); Thomas Netscher, Bad Krozingern (CH); Elisabeth Stoecklin, Arlesheim (CH)

Correspondence Address: NIXON & VANDERHYE, PC, 901 NORTH GLEBE ROAD, 11TH FLOOR, ARLINGTON, VA, 22203, US

(21) Appl. No.: 11/885,665

(22) PCT Filed: Feb. 28, 2006
(86) PCT No.: PCT/EP06/01811

§ 371 Date: Jan. 25, 2008

(30) Foreign Application Priority Data
Mar. 9, 2005 (EP) 05 005 192.9

(51) Int. Cl. C40B 30/04

(52) U.S. Cl. 506/9

(57) ABSTRACT

Biologically active compounds (e.g. from the groups of pharmaceutical drugs, cofactors, hormones, vitamins or phytochemicals) often consist of two or more stereoisomers (enantiomers or diastereoisomers) which may differ in their pharmacodynamic/kinetic, toxicological and biological properties. These differences are so far difficult to detect. A well known example for a biologically active compound and its counterpart is vitamin E which is predominantly administered as two different ‘forms’, one derived from natural sources (mainly soybeans), and one from production by chemical total-synthesis. While vitamin E from natural sources occurs as a single stereoisomer (RRR-α-tocopherol), so-called synthetic vitamin E (all-rac-α-tocopherol) is an equimolar mixture of eight stereoisomers. The present invention is directed to a method for calculating the biological activity of a biologically active compound (e.g. RRR-α-tocopherol) and a counterpart thereof (e.g. all-rac-α-tocopherol), comprising the steps of: culturing a plurality of cells in a culture medium and treating the cells with different concentrations of either said compound or said counterpart thereof; or treating a plurality of animals or plants with different concentrations of either said compound or said counterpart; preparing samples from the treated cells or animals or plants containing a pool of target nucleic acids comprising RNA transcripts; detecting the expression of genes in said cells by measuring the amount of transcripts of said genes to obtain a target expression pattern by hybridizing said pool of target nucleic acids to an array of nucleic acid probes immobilized on a surface, wherein said array comprising at least 10 different nucleic acids, some of which comprise control probes, and wherein each different nucleic acid is localized in a known location of said surface; quantifying the hybridization of said nucleic acids to said array by comparing binding of matched and control probes; calculating the biological activity of the compound and its counterpart therefrom.

Biologically active compounds have discrete bio-activities towards animal biochemistry and metabolism. Biologically active compounds can provide health benefits as substrates for biochemical reactions, cofactors of enzymatic reactions, inhibitors of enzymatic reactions, absorbents/sequestrants that bind to and eliminate undesirable constituents in the intestine, compounds that enhance the absorption and/or stability of essential nutrients; selective growth factors for beneficial gastrointestinal bacteria, fermentation substrates for oral, gastric or intestinal bacteria, or selective inhibitors of deleterious intestinal bacteria.

Biologically active compounds hereinafter defined as BAC belong to the groups of pharmaceutical drugs, cofactors, hormones and vitamins and include phytochemicals as for example terpenoids, phenolics, alkaloids as well as enzymes and peptides.

The rapid growth in the use of BAC in nutraceutical and functional foods requires that the food and pharmaceutical industries face new challenges in addressing worldwide public concern over the efficacy and safety of supplements and foods claimed to be health-promoting; in government regulations related to safety, labeling and health claims for products that contain BAC; in the manufacturing of foods with different qualities and stabilities; and in marketing issues, particularly as they relate to consumers recognizing added value.

Several commonly prescribed drugs, as well as other pharmacologically active compounds such as vitamins are administered as mixtures of stereoisomers. Characterized by their individual three-dimensional configurations, stereoisomers may possess their own unique chemistry, biological activity and pharmacokinetic profile. Such an example is represented by α-tocopherol (vitamin E) which possesses three chiral centres at positions 2, 4′ and 8′, giving rise to four diastereoisomeric pairs of enantiomers, i.e. eight individual stereoisomers (RRR, RSR, RRS, RSS, SRR, SSR, SRS, and SSS).

While α-tocopherol contained in vegetable oils (nuts, seeds, grains) or industrially produced from natural sources (mainly soybeans), occurs as a single stereoisomer (RRR-α-tocopherol, RRR-α-T), α-tocopherol obtained by chemical total-synthesis (all-rac-α-tocopherol, all-rac-α-T) is an equimolar mixture of all eight stereoisomers.

The biological activity of a compound describes its specific ability or capacity to achieve an intended biological effect such as, in the case of vitamin E, prevention of fetal resorption, prevention of red blood cell haemolysis, curative myopathy and more. The biological potency of a substance is defined as the quantitative measure of its biological activity and is usually expressed in terms of EC50 and IC50 (concentration or dose of a compound that produces 50% of the maximal possible effect).

Based on animal studies, it has been suggested that vitamin E stereoisomers possess equal biological activity but different biological potencies. In this regard, the biological potency of RRR-α-T was calculated to be 1.36 times of the value of its total-synthetic analogue all-rac-α-T. This factor is believed to reflect the differences in distribution and clearance of the two forms of α-tocopherol in plasma and tissues.

All known methods share the limitation to measure the biological activity and potency at the level of a single, specific assay. However, it is to assume that any active ingredient, including chiral compounds, might exert more than one biological activity. As a consequence, a given assay can only measure the potency in regard to this one activity, and different values may be obtained if different endpoints are considered.

It has been found that based on the knowledge that vitamin E regulates enzyme activity, cell proliferation as well as the transcription of numerous genes, with respect to the monitoring of gene transcriptional activity, remarkable advances in molecular techniques have made it possible to quantify changes in gene expression at a global, i.e. genome-wide, scale. The present invention gives the possibility to identify, quantify and compare all transactivation activities of a given compound, in the case as described RRR- and all-rac-α-T, on a global level overcoming the limitation of a “single assay”-based characterization.

Many biological functions induced by the uptake of BAC are accomplished by altering the expression of various genes through transcriptional (e.g. through control of initiation, provision of RNA precursors, RNA processing, etc.) and/or translational control. Understanding and quantifying the functions and regulatory relationships between the expression of a number of genes and BAC inducing said genes is therefore a need to develop a systematic analysis approach related to safety, labeling and health claims for products that contain BAC.

Therefore, the present invention relates to a new method, preferred a new in-vitro method, for the analysis of the biological activity of BAC. More precisely, the invention provides a method for mapping and analysing the complex regulatory relationships between BAC and gene expression and for quantifying the biological activity of the BAC based on the gene expression mapping.

The stated object of the invention is achieved by the method according to claim 1.

Advantageous embodiments of the invention become evident from the dependent claims.

Specifically, gene expression analyzing is used to compare the biological activity, for example the bio-potency, of a specific BAC with the bio-potency of a counterpart in an in-vitro assay. In such embodiments, the expression of more than 10 genes, preferably more than 100 genes, more preferably more than 1,000 genes and most preferably more than 5,000 genes are analysed in a large number of samples of cells. Ultimately, the expression data are analyzed to develop a map describing the complex relationships between the BAC and the gene expression and the biological activities of the two compounds are calculated.

The counterpart of the specific BAC can be a stereoisomer or a mixture of stereoisomers of the BAC which may differ in the pharmacodynamic, kinetic, toxicological and biological properties.

Instead of measuring and comparing the biological activity of stereoisomers also the biological activity of “regioisomers” could be measured and compared with each other. “Regioisomers” in the context of the present invention are compounds that have at least one functional group at a different position; an example is a pair of compounds whereby the one compound has the functional group in x-position and another compound which has the same functional group in y-position, whereby x and y are different, e.g. 2-hydroxy-cholesterol and 3-hydroxycholesterol. A “functional group” is hereby a substituent containing a heteroatom, e.g. hydroxyl, thiol, halogeno, carboxyl etc.

The biological activity of “homologous compounds A and B”, i.e. compounds which differ in at least one functional group (e.g. chloro instead of bromo, acylated amines (amides) instead of amines, acylated alcohols (esters) instead of alcohols, methyl ester instead of ethyl ester, etc.) or in the length of the hydrocarbon chain (difference of one methylene or ethylene group etc.) may also be measured and compared with the process of the present invention.

Not only the biological activity of different compounds may be measured and compared with each other, but also that of the same compound embedded in at least two different matrices, i.e. two different formulations of the same substance (the compound in matrix C and the compound in matrix D with C and D being different from each other). The term “matrices/matrix” encompasses any material not reacting chemically, i.e. not forming covalent bonds, with the compound whose biological activity is tested and preferably being selected from the group consisting of (non-hydrolysed, hydrolysed) gelatine (especially fish gelatine, poultry gelatine, bovine gelatine, pigskin gelatine), food starch modified (especially OSA (ortho-succinylacetylated)), starch, (modified) plant proteins, milk protein, soluble fibers, polysaccharides, pectin, maltodextrines, starch hydrolysates (e.g. glucose syrup) and plant gums. The expression “embedded” encompasses “coated”, “encapsulated”, “micro-encapsulated” and “spray-dried”. A BAC embedded in a matrix may also be manufactured by a powder catch process, or may be in the form of beadlets, emulsions, nano-emulsions, micro-emulsions or suspensions.

Any of a variety of BAC can be used in the method according to the invention. For example the biologically active compound is selected from the group consisting of: (R)-enantiomers, cis-isomers, Z-isomers, endo-isomers, (−)-atropisomers, regioisomers with a functional group in x-position, compounds A, compounds embedded in matrix C, and, in the case of compounds possessing more than one stereocenter, single specific stereoisomers, and the counterpart is selected from the group consisting of: (S)-enantiomers, trans-isomers, E-isomers, exo-isomers, (+)-atropisomers, regioisomers with the same functional group in y-position, compounds B being homologous to compounds A, compounds embedded in matrix D, and, in the case of compounds possessing more than one stereocenter, epimers (e.g. anomers) or diastereoisomers of the single specific stereoisomer, or vice versa, or the biologically active compound and its counterpart being selected from a pair of compounds having the opposite helical chirality. In the process of the present invention at least two compounds are compared with each other, i.e. that the comparison of more than two compounds is also within the scope of the present invention.

In another example the biologically active compound and the counterpart are stereoisomers or in just another example and described above, the biologically active compound is a pure substance (i.e. natural vitamin E) with a certain defined stereochemistry whereby the counterpart (synthetic vitamin E) is a mixture of stereoisomers (in any ratio) of this pure substance.

In yet another aspect of the invention the counterpart of the specific BAC is a compound which differs from the BAC in chemical structure and class or is a mixture or composition containing such a compound, wherein the counterpart is used for similar or equal indications in human or animal nutrition and health as the BAC.

Non-limiting examples of biochemical factors and their counterparts that may be used in the present invention's method are:
Vitamin E. The term vitamin E as used herein includes racemic vitamin E (all-rac-α-tocopherol) or natural vitamin E ((2R,4′R,8′R)-α-tocopherol), as well as derivatives thereof which have biological vitamin E activity, e.g. carboxylic acid esters, such as vitamin E acetate, propionate, butyrate or succinate.
Vitamin C. The term vitamin C as used herein includes derivatives thereof which have biological vitamin C activity, e.g. esters and salts, such as sodium ascorbate, sodium ascorbyl phosphate, and ascorbyl palmitate.
Carotenoids as for example astaxanthin ((3S,3′S)-3,3′-dihydroxy-β,β-carotene-4,4′-dione), β-carotene, β-cryptoxanthin ((3R)-β,β-carotene-3-ol), lutein ((3R,3′R,6′R)-β, ε-carotene-3,3′-diol), zeaxanthin ((3R,3′R)-β,β-carotene-3,3′-diol) and/or isomers, stereoisomers and/or esters thereof.
Epigallocatechin gallate (EGCG) and/or (−)-epicatechin gallate (ECG) and/or one or more derivatives thereof.
Genistein aglycone (4′,5,7-trihydroxyisoflavone) and/or one or more derivatives thereof (genistein glucosides, genistein sulfates, genistein glucuronides).
Resveratrol (cis-3,4′,5-trihydroxystilbene and/or trans-3,4′,5-trihydroxystilbene) and/or one or more derivatives thereof.
Vitamin A and/or one or more derivatives thereof (all-trans retinol or all-trans retinyl acetate or all-trans retinyl palmitate).
Vitamin B₂, B₆, B₁₂ and/or one or more derivatives thereof.
Vitamin D₂ or vitamin D₃ and/or one or more derivatives thereof.
Biotin,
polyunsaturated fatty acids,
curcumin and/or derivatives thereof.

### Definitions

Mismatch control: The term “mismatch control” or “mismatch probe” refers to a probe whose sequence is deliberately selected not to be perfectly complementary to a particular target sequence. For each mismatch (MM) control in a high-density array there typically exists a corresponding perfect match (PM) probe that is perfectly complementary to the same particular target sequence. The mismatch may comprise one or more bases. While the mismatch(es) may be located anywhere in the mismatch probe, terminal mismatches are less desirable as a terminal mismatch is less likely to prevent hybridization of the target sequence. In a particularly preferred embodiment, the mismatch is located at or near the center of the probe such that the mismatch is most likely to destabilize the duplex with the target sequence under the test hybridization conditions.

mRNA or transcript: The term “mRNA” refers to transcripts of a gene. Transcripts are RNA including, for example, mature messenger RNA ready for translation, products of various stages of transcript processing. Transcript processing may include splicing, editing and degradation.

Nucleic Acid: The terms “nucleic acid” or “nucleic acid molecule” refer to a deoxyribonucleotide or ribonucleotide polymer in either single- or double-stranded form, and unless otherwise limited, would encompass analogues of natural nucleotide that can function in a similar manner as naturally occurring nucleotide. An oligo-nucleotide is a single-stranded nucleic acid of 2 to n bases, where n may be greater than 500 to 1000. Nucleic acids may be cloned or synthesized using any technique known in the art. They may also include non-naturally occurring nucleotide analogues, such as those which are modified to improve hybridization and peptide nucleic acids.

Nucleic acid encoding a regulatory molecule: The regulatory molecule may be DNA, RNA or protein. Thus for example DNA sites which bind protein or other nucleic acid molecules are included within the class of regulatory molecules encoded by a nucleic acid.

Perfect match probe: The term “perfect match probe” refers to a probe that has a sequence that is perfectly complementary to a particular target sequence. The test probe is typically perfectly complementary to a portion (subsequence) of the target sequence. The perfect match (PM) probe can be a “test probe”, a “normalization control” probe, an expression level control probe and the like. A perfect match control or perfect match probe is, however, distinguished from a “mismatch control” or “mismatch probe.”

Probe: As used herein a “probe” is defined as a nucleic acid, capable of binding to a target nucleic acid of complementary sequence through one or more types of chemical bonds, usually through complementary base pairing, usually through hydrogen bond formation. As used herein, a probe may include natural [adenin (A), guanin (G), uracil (u), cytosin (C) or thymin (T)] or modified bases (7-deazaguanosine, inosine, etc.). In addition, the bases in probes may be joined by a linkage other than a phosphodiester bond, so long as it does not interfere with hybridization. Thus, probes may be peptide nucleic acids in which the constituent bases are joined by peptide bonds rather than phosphodiester linkages.

Target nucleic acid: The term “target nucleic acid” refers to a nucleic acid (often derived from a biological sample), to which the probe is designed to specifically hybridize. It is either the presence or absence of the target nucleic acid that is to be detected, or the amount of the target nucleic acid that is to be quantified. The target nucleic acid has a sequence that is complementary to the nucleic acid sequence of the corresponding probe directed to the target. The term target nucleic acid may refer to the specific subsequence of a larger nucleic acid to which the probe is directed or to the overall sequence (e.g., gene or mRNA) whose expression level is desired to detect. The difference in usage will be apparent from context.

Stringent conditions: The term “stringent conditions” refers to conditions under which a probe will hybridize to its target subsequence, but with only insubstantial hybridization to other sequences or to other sequences such that the difference may be identified. Stringent conditions are sequence-dependent and will be different in different circumstances. Longer sequences hybridize specifically at higher temperatures. Generally, stringent conditions are selected to be about 5° C. lower than the thermal melting point (Tm) for the specific sequence at a defined ionic strength and pH.

Thermal melting point (Tm): The Tm is the temperature, under defined ionic strength, pH, and nucleic acid concentration, at which 50% of the probes complementary to the target sequence hybridize to the target sequence at equilibrium. As the target sequences are generally present in excess, at Tm, 50% of the probes are occupied at equilibrium. Typically, stringent conditions will be those in which the salt concentration is at least about 0.01 to 1.0 M sodium salt (or other salts) concentration at pH 7.0 to 8.3 and the temperature is at least about 30° C. for short probes (e.g. 10 to 50 nucleotides). Stringent conditions may also be achieved with the addition of destabilizing agents such as formamide.

Quantifying: The term “quantifying” when used in the context of quantifying transcription levels of a gene can refer to absolute or to relative quantification. Absolute quantification may be accomplished by inclusion of known concentration(s) of one or more target nucleic acids (e.g. control nucleic acids such as Bio B® (Affymetrix Inc., Santa Clara, Calif., USA) or with known amounts the target nucleic acids themselves) and referencing the hybridization intensity of unknowns with the known target nucleic acids (e.g. through generation of a standard curve). Alternatively, relative quantification can be accomplished by comparison of hybridization signals between two or more genes, or between two or more treatments to quantify the changes in hybridization intensity and, by implication, transcription level.

### Use of Gene Expression Monitoring for Genetic Network Mapping and Quantification

The methods involve quantifying the level of expression of a large number of genes. A high density oligonucleotide array can be used to hybridize with a target nucleic acid sample to detect the expression level of a large number of genes, preferably more than 10, more preferably more than 100, and most preferably more than 1000 genes.

A variety of nucleic acid samples are prepared according to the methods of the invention to represent many states of the genetic network. By comparing the expression levels of those samples, regulatory relationships among genes can be determined with a certain statistical confidence. A dynamic map can be constructed based upon expression data.

Activity of a gene is reflected by the activity of its product(s): the proteins or other molecules encoded by the gene. Those product molecules perform biological functions. Directly measuring the activity of a gene product is, however, often difficult for certain genes. Instead, the immunological activities or the amount of the final product(s) or its peptide processing intermediates are determined as a measurement of the gene activity. More frequently, the amount or activity of intermediates, such as transcripts, RNA processing intermediates, or mature mRNAs are detected as a measurement of gene activity.

In many cases, the form and function of the final product(s) of a gene is unknown. In those cases, the activity of a gene is measured conveniently by the amount or activity of transcript(s), RNA processing intermediate(s), mature mRNA(s) or its protein product(s) or functional activity of its protein product(s).

Any methods that measure the activity of a gene are useful for at least some embodiments of this invention. For example, traditional Northern blotting and hybridization, nuclease protection, RT-polymerase chain reaction (RT-PCR) and differential display have been used for detecting gene activity.

The nucleic acid probes immobilized on a surface defined for example in high density arrays are particularly useful for monitoring the expression control at the transcriptional, RNA processing and degradation level. The fabrication and application of high density arrays in gene expression monitoring have been disclosed previously in, for example, WO 97/10365 and WO 92/10588, both incorporated herein for all purposes by reference. In embodiments using high density arrays, high density oligonucleotide arrays can be synthesized using methods such as the Very Large Scale Immobilized Polymer Synthesis (VLSIPS) disclosed in U.S. Pat. No. 5,445,934 incorporated herein for all purposes by reference. Each oligonucleotide occupies a known location on a substrate. A nucleic acid target sample is hybridized with a high density array of oligonucleotides and then the amount of target nucleic acids hybridized to each probe in the array is quantified. One preferred quantifying method is to use confocal microscope and fluorescent labels. The GeneChip® system (Affymetrix, Santa Clara, Calif.) is particularly suitable for quantifying the hybridization; however, it will be apparent to those of skill in the art that any similar systems or other effectively equivalent detection methods can also be used.

Preferred high density arrays for gene function identification and genetic network mapping comprise greater than about 100, preferably greater than about 1000, more preferably greater than about 16,000 and most preferably greater than 65,000 or 250,000 or even greater than about 1,000,000 different oligonucleotide probes, preferably in less than 1 cm² of surface area. The oligonucleotide probes range from about 5 to about 50 or about 500 nucleotides, more preferably from about 10 to about 40 nucleotides and most preferably from about 15 to about 40 nucleotides in length.

### Providing a Nucleic Acid Sample

In one embodiment, such sample is a homogenate of cells or tissues or other biological samples. Preferably, such sample is a total RNA preparation of a biological sample. More preferably in some embodiments, such a nucleic acid sample is the total mRNA isolated from a biological sample. Those of skill in the art will appreciate that the total mRNA prepared with most methods includes not only the mature mRNA, but also the RNA processing intermediates and nascent pre-mRNA transcripts. For example, total mRNA purified with a poly (dT) column contains RNA molecules with poly (A) tails. Those molecules could be mature mRNA, RNA processing intermediates, nascent transcripts or degradation intermediates.

Biological samples may be of any biological tissue or fluid or cells from any organism. Frequently the sample can be derived from an animal, plant or human (patient). Typical biological samples include, but are not limited to, sputum, blood, blood cells (e.g. white cells), tissue or fine needle biopsy samples, urine, peritoneal fluid, and pleural fluid, or cells therefrom. Biological samples may also include sections of tissues, such as frozen sections or formalin fixed sections taken for histological purposes.

Methods of isolating total RNA/mRNA are also well known to those of skill in the art. For example, methods of isolation and purification of nucleic acids are described in detail in Chapter 3 of Laboratory Techniques in Biochemistry and Molecular Biology: Hybridization With Nucleic Acid Probes, Part I. Theory and Nucleic Acid Preparation, P. Tijssen, ed. Elsevier, N.Y. (1993) and Chapter 3 of Laboratory Techniques in Biochemistry and Molecular Biology: Hybridization With Nucleic Acid Probes, Part I. Theory and Nucleic Acid Preparation, P. Tijssen, ed. Elsevier, N.Y. (1993).

Frequently, it is desirable to amplify the nucleic acid sample prior to hybridization. One of skill in the art will appreciate that whatever amplification method is used, if a quantitative result is desired, care must be taken to use a method that maintains or controls for the relative frequencies of the amplified nucleic acids to achieve quantitative amplification. Methods of “quantitative” amplification are well known to those of skill in the art. For example, quantitative PCR involves simultaneously co-amplifying a known quantity of a control sequence using the same primers. This provides an internal standard that may be used to calibrate the PCR reaction. The high density array may then include probes specific to the internal standard for quantification of the amplified nucleic acid.

### Hybridizing RNAs with an Array of Nucleic Acid Probes

One of skill in the art will appreciate that an enormous number of array designs are suitable for the practice of this invention.

Nucleic acid hybridization simply involves contacting a probe and target nucleic acid under conditions where the probe and its complementary target can form stable hybrid duplexes through complementary base pairing. The nucleic acids that do not form hybrid duplexes are then washed away leaving the hybridized nucleic acids to be detected, typically through detection of an attached detectable label. It is generally recognized that nucleic acids are denatured by increasing the temperature or decreasing the salt concentration of the buffer containing the nucleic acids. Under low stringency conditions (e.g. low temperature and/or high salt concentration) hybrid duplexes (e.g. DNA:DNA, RNA:RNA, or RNA:DNA) will form even where the annealed sequences are not perfectly complementary. Thus specificity of hybridization is reduced at lower stringency. Conversely, at higher stringency (e.g. higher temperature and/or lower salt concentration) successful hybridization requires fewer mismatches.

One of skill in the art will appreciate that hybridization conditions may be selected to provide any degree of stringency. In a preferred embodiment, hybridization is performed at low stringency in this case in 6.times.SSPE-T at 37° C. (0.005% Triton X-100) to ensure hybridization and then subsequent washes are performed at higher stringency (e.g. 1.times.SSPE-T at 37° C.) to eliminate mismatched hybrid duplexes. Successive washes may be performed at increasingly higher stringency (e.g. down to as low as 0.25.times.SSPE-T at 37° C. to 50° C.) until a desired level of hybridization specificity is obtained. Stringency can also be increased by addition of agents such as formamide. Hybridization specificity may be evaluated by comparison of hybridization to the test probes with hybridization to the various controls that can be present (e.g. expression level control, normalization control, mismatch controls, etc.).

In general, there is a tradeoff between hybridization specificity (stringency) and signal intensity. Thus, in a preferred embodiment, the wash is performed at the highest stringency that produces consistent results and that provides a signal intensity greater than approximately 10% of the background intensity. Thus, in a preferred embodiment, the hybridized array may be washed at successively higher stringency solutions and read between each wash. Analysis of the data sets thus produced will reveal a wash stringency above which the hybridization pattern is not appreciably altered and which provides adequate signal for the particular oligonucleotide probes of interest.

Background signal can be reduced by the use of a detergent (e.g. C-TAB) or a blocking reagent (e.g. sperm DNA, cot-1 DNA, etc.) during the hybridization to reduce non-specific binding. The use of blocking agents in hybridization is well known to those of skill in the art.

The stability of duplexes formed between RNAs or DNAs are generally in the order of RNA:RNA>RNA:DNA>DNA:DNA, in solution. Long probes have better duplex stability with a target, but poorer mismatch discrimination than shorter probes (mismatch discrimination refers to the measured hybridization signal ratio between a perfect match probe and a single base mismatch probe). Shorter probes (e.g. 8-mers) discriminate mismatches very well, but the overall duplex stability is low.

### Signal Detection

In a preferred embodiment, the hybridized nucleic acids are detected by detecting one or more labels attached to the sample nucleic acids. The labels may be incorporated by any of a number of means well known to those of skill in the art. However, the label can be simultaneously incorporated during the amplification step in the preparation of the sample nucleic acids. Thus, for example, polymerase chain reaction (PCR) with labeled primers or labeled nucleotides will provide a labeled amplification product.

Alternatively, a label may be added directly to the original nucleic acid sample (e.g. mRNA, polyA mRNA, cDNA, etc.) or to the amplification product after the amplification is completed. Means of attaching labels to nucleic acids are well known to those of skill in the art and include, for example nick translation or end-labeling (e.g. with a labeled RNA) by kinasing of the nucleic acid and subsequent attachment (ligation) of a nucleic acid linker joining the sample nucleic acid to a label (e.g. a fluorophore).

Detectable labels suitable for use in the present invention include any composition detectable by spectroscopic, photochemical, biochemical, immunochemical, electrical, optical or chemical means. Useful labels in the present invention include biotin for staining with labeled streptavidin conjugate, magnetic beads, fluorescent dyes, radiolabels, enzymes and colorimetric labels.

Means of detecting such labels are well known to those of skill in the art. Thus, for example, radiolabels may be detected using photographic film or scintillation counters, fluorescent markers may be detected using a photodetector to detect emitted light. Enzymatic labels are typically detected by providing the enzyme with a substrate and detecting the reaction product produced by the action of the enzyme on the substrate, and calorimetric labels are detected by simply visualizing the colored label.

The label may be added to the target (sample) nucleic acid(s) prior to, or after the hybridization. So called “direct labels” are detectable labels that are directly attached to or incorporated into the target (sample) nucleic acid prior to hybridization. In contrast, so called “indirect labels” are joined to the hybrid duplex after hybridization. Often, the indirect label is attached to a binding moiety that has been attached to the target nucleic acid prior to the hybridization.

Means of detecting labeled target (sample) nucleic acids hybridized to the probes of the high density array are known to those of skill in the art. Thus, for example, where a colorimetric label is used, simple visualization of the label is sufficient. Where a radioactive labeled probe is used, detection of the radiation (e.g. with photographic film or a solid state detector) is sufficient.

The target nucleic acids can be labeled with a fluorescent label and the localization of the label on the probe array is accomplished with fluorescent microscopy. The hybridized array is excited with a light source at the excitation wavelength of the particular fluorescent label and the resulting fluorescence at the emission wavelength is detected.

The confocal microscope may be automated with a computer-controlled stage to automatically scan the entire high density array. Similarly, the microscope may be equipped with a phototransducer (e.g. a photomultiplier, a solid state array, a CCD camera, etc.) attached to an automated data acquisition system to automatically record the fluorescence signal produced by hybridization to each oligonucleotide probe on the array.

One of skill in the art will appreciate that methods for evaluating the hybridization results vary with the nature of the specific probe nucleic acids used as well as the controls provided. In the simplest embodiment, simple quantification of the fluorescence intensity for each probe is determined. This is accomplished simply by measuring probe signal strength at each location (representing a different probe) on the high density array (e.g. where the label is a fluorescent label, detection of the amount of fluorescence (intensity) produced by a fixed excitation illumination at each location on the array). Comparison of the absolute intensities of an array hybridized to nucleic acids from a “test” sample with intensities produced by a “control” sample provides a measure of the relative expression of the nucleic acids that hybridize to each of the probes.

One of skill in the art, however, will appreciate that hybridization signals will vary in 30 strength with efficiency of hybridization, the amount of label on the sample nucleic acid and the amount of the particular nucleic acid in the sample. Typically nucleic acids present at very low levels (e.g. <1 pM) will show a very weak signal. At some low level of concentration, the signal becomes virtually indistinguishable from background. In evaluating the hybridization data, a threshold intensity value may be selected below which a signal is not counted as being essentially indistinguishable from background.

Where it is desirable to detect nucleic acids expressed at lower levels, a lower threshold is chosen. Conversely, where only high expression levels are to be evaluated a higher threshold level is selected. In a preferred embodiment, a suitable threshold is about 10% above that of the average background signal.

### Statistical Analysis

The purpose of statistical analysis is to establish and test causal models for the genetic network and the quantification of gene expression induced by a specific BAC. A variety of statistical methods is useful for some of the embodiments.

The biological activity of a compound describes its specific ability or capacity to achieve an intended biological effect. Therefore the determination of biological potency of a substance is a useful parameter to quantify by the inventive method. As described before, the bio-potency is defined as the quantitative measure of its biological activity and is usually expressed in terms of EC50 and IC50 (concentration or dose of a compound that produces 50% of the maximal possible effect).

### EXAMPLES

The present invention will now be illustrated in more detail by the following two examples, which are not meant to limit the scope of the invention. Example 1 is described with reference to the drawings. In the drawings,

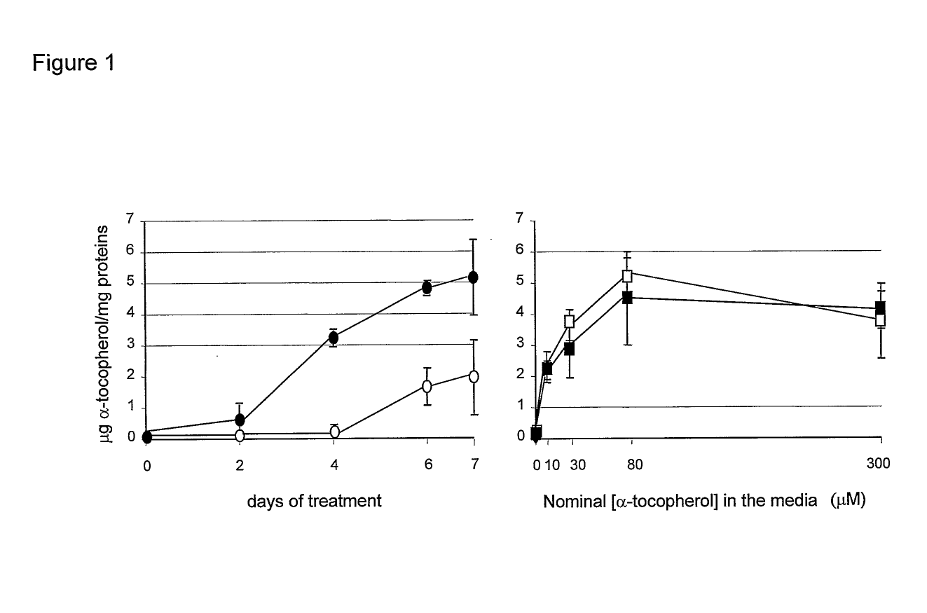

FIG. 1 shows the enrichment of HepG2 cells with α-tocopherol: a) Every 48 hours, cells in the 10 μM (◯) and 300 μM all-rac-α-T () treatment groups were collected and cellular vitamin E concentrations were measured. b) Intracellular vitamin E was measured for all concentration-groups at day 7 of treatments. RRR-α-tocopherol: □ all-rac-α-tocopherol: ▪. The given values are means and SD of triplicate dishes. The data shown in FIG. 1a and 1b were compiled from 2 independent experiments.

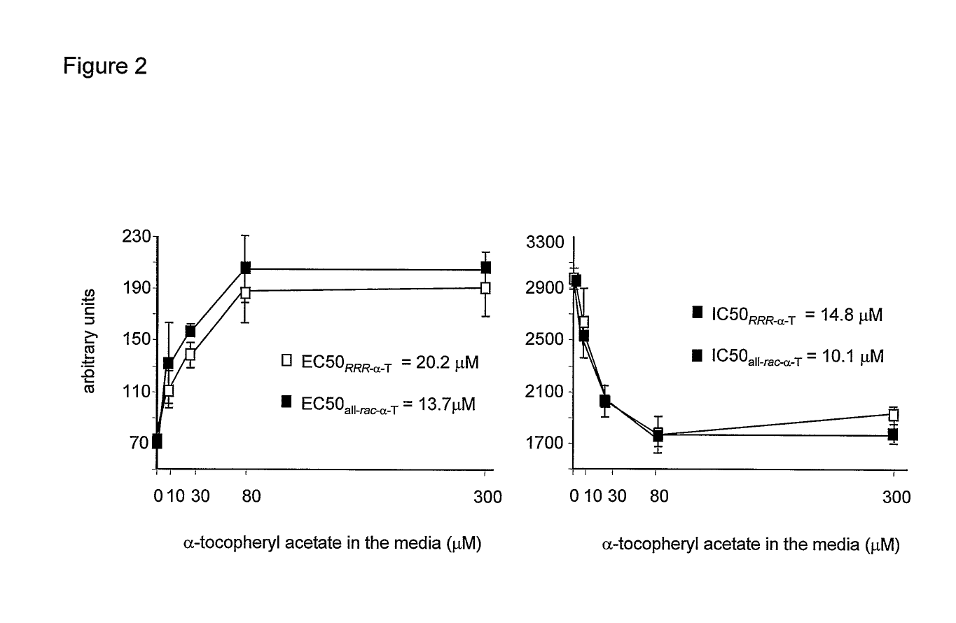

FIG. 2 shows the dose-dependent transcriptional activation of fibrinogen (a) and inhibition of chondroitin N-acetyl galactosaminyl transferase-2 (b) genes by RRR-α-tocopherol (□) and all-rac-α-tocopherol (▪): HepG2 cells were treated for 7 days with the indicated concentrations of α-tocopherol acetate. Relative mRNA levels were measured as described below. Values are the means and SD of quadruplicate determinations.

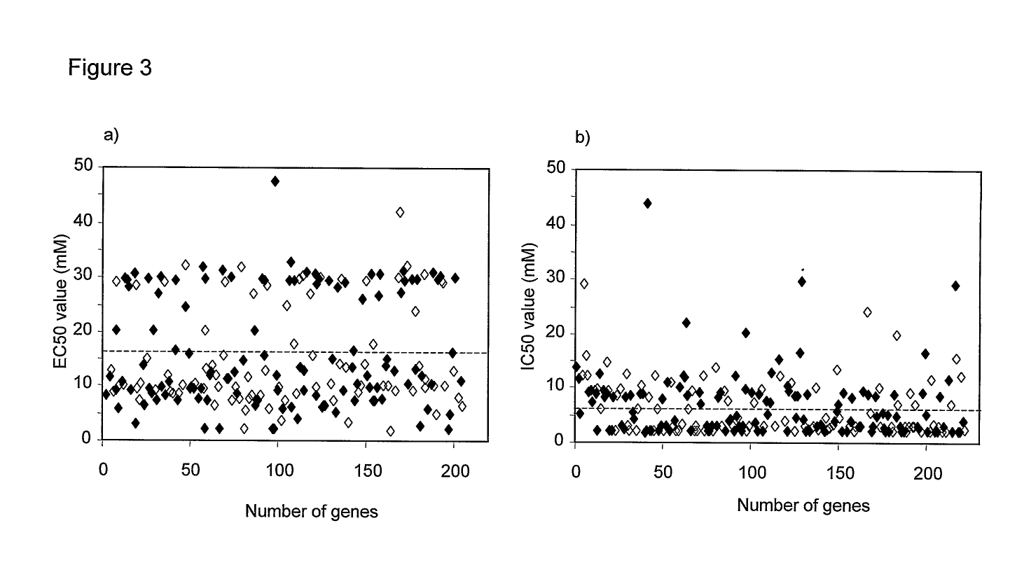

FIG. 3 shows the genes found to be regulated in a dose-dependent way: a) From the 215 genes found to be regulated in a dose-dependent way the EC50 or IC50 values were calculated. 104 genes were found to be induced and 111 genes repressed by α-tocopherol. The resulting 208 EC50 values, 104 EC50s from RRR-α-T (♦) and 104 EC50s from all-rac-α-T (⋄) respectively, were plotted (a). From the 111 genes repressed by α-tocopherol, 111 IC50s from RRR-α-T (♦) and 111 IC50s from all-rac-α-T (⋄) were calculated and plotted (b). Average of the EC50s and IC50s: . . . .

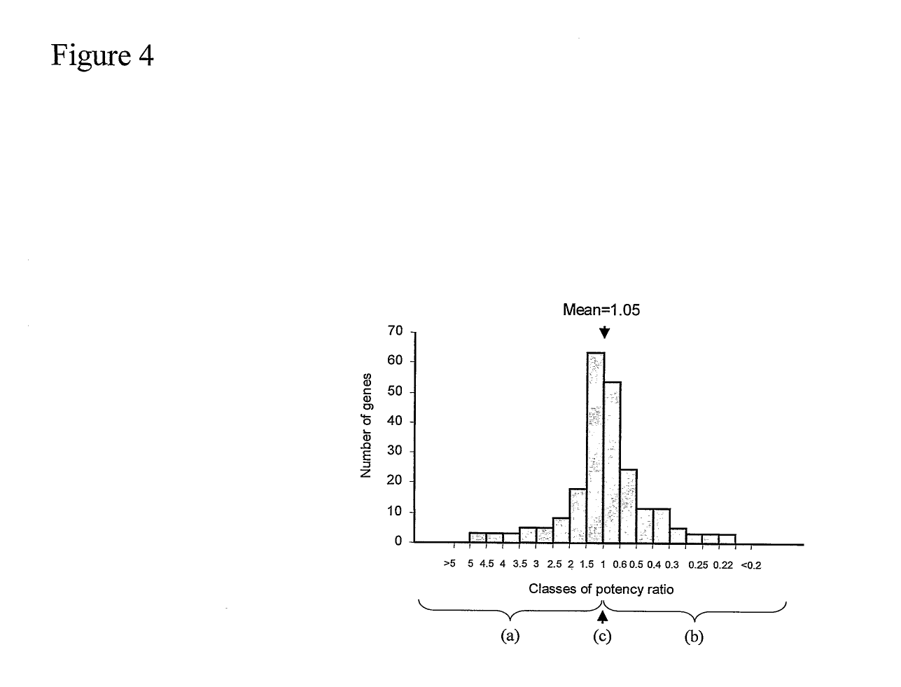

FIG. 4 shows the distribution of bio-potency ratios: The potency ratios calculated for the 215 genes were distributed in ratio-classes as indicated. (a) Ratio-classes of genes where RRR-α-T was found to be more potent than all-rac-α-T (i.e. EC50_{RRR-α-T}<EC50_{all-rac-α-T} or IC50_{RRR-α-T}<IC50_{all-rac-α-T}). (b) Ratio-classes of genes where all-rac-α-T was found to be more potent than RRR-α-T (i.e. EC50_{all-rac-α-T}<EC50_{RRR-α-T} or IC50_{all-rac-α-T}<IC50_{RRR-α-T}). (c) A ratio of 1 corresponds to bioequivalency with respect to potency between the two “forms” of vitamin E. The calculated average of the 215 independent potency ratios was found to be 1.05.

### EXAMPLE 1

### Comparison of the Biological Potency of Vitamin E Compounds in Vivo

### Cells and Cell Culture Media:

HepG2 cells (ATCC HB-8065) were cultured in 6 cm dishes in DMEM medium (GIBCO-Invitrogen, Switzerland) with 10% NU serum™ (Becton Dickinson, Switzerland) containing 1% Pen/Strep and undetectable amounts of vitamin E (detection limit 20 nM). Vitamin E compounds were applied as the acetate derivatives: RRR-α-tocopheryl acetate (Sigma and DSM Nutritional Products Ltd., Switzerland; 99-99.5 weight %, determined by gas chromatography) and all-rac-α-tocopheryl acetate (DSM Nutritional Products Ltd, Kaiseraugst, Switzerland; 98.0-99.5 weight %, determined by gas chromatography) were dissolved in 100% ethanol to prepare stock solutions. Treatment media were prepared by the addition of RRR-α-tocopheryl acetate (RRR-α-Tac) or all-rac-α-tocopheryl acetate (all-rac-α-Tac) to the basic medium at the following final concentrations: 0 (ethanol only, 1% final concentration), 10, 30, 80 and 300 μM. Treatment media were aliquoted and stored at −20° C. The vitamin E acetate treatment was performed for 7 days during the logarithmic growth phase of the cells. All treatment media were exchanged for fresh media every 24 hours. This treatment strategy has been chosen in the attempt to keep vitamin E acetate concentrations stable over time and to reach steady state intracellular vitamin E concentrations at 7 days of supplementation. All treatments were performed in quadruplicate dishes.

### Cellular α-Tocopherol Concentrations:

Adherent HepG2 cells were trypsinized, collected and washed three times with PBS containing 1% bovine serum albumin. Cells were saponified in a methanolic potassium hydroxide solution. The solution was diluted with 35% ethanol and extracted with hexane/toluene. α-Tocopheryl acetate and hydrolyzed α-tocopherols were quantified by isocratic HPLC analysis.

Total RNA Extraction, cRNA Preparation and Affymetrix GeneChip® Hybridization:

Cells were washed three times with PBS and lyzed with RTL buffer (Qiagen, Basel, Switzerland). Total RNA isolation was performed using RNeasy mini spin columns (Qiagen) and DNase digested on the columns (RNase-Free DNase Set, Qiagen) according to the manufacturer's description. cRNA preparation and Affymetrix GeneChip (U133A) hybridization were performed as described.

### GeneChip® Microarray Expression Analysis:

Data processing was carried out using the RACE-A analysis tool (Roche Bioinformatics, Basel, Switzerland) as described. Briefly, the arrays were normalized against the mean of the total sum of Average Difference (AvgDiff) values across all arrays used. Mean Average Difference values (MeanAvgDiff) were calculated as the means of one experiment performed in quadruplicate. Possible outliers were identified using the procedure of Nalimov with a 95% confidence interval. Subsequently, mean change factors (Chgf) for each individual gene were calculated among the different treatment groups and control using pair wise comparisons, and statistical significance was assessed by Student's t-test with prior testing for the normal distribution of the data. Applicant selected for those genes showing a dose-dependent regulation by vitamin E, i.e. maximal MeanAvgDiff>10 combined with a significant (p<0.05) differential Chgf between the vitamin E supplemented groups and the control group. The analysis of the experimental data obtained upon stimulation/treatment of the cells with RRR-α-Tac or all-rac-α-Tac was performed independently from each other.

### Calculation of the EC50 and IC50 Values:

EC50 and IC50 values, respectively, were determined by applying the standard four parameter model [y=a+(b−a)/(1+(x/c)̂d)] using the XL-Fit Software 3.0 (IDBS Inc. Emeryville, USA), where y is the normalized gene expression, x is the concentration of RRR-α-tocopherol or all-rac-α-tocopherol in the media and c corresponds to the EC50 and IC50 values, respectively. The potency-ratios were calculated as following: EC50_{RRR-α-T}/EC50_{all-rac-α-T} and IC50_{RRR-α-T}/IC50_{all-rac-α-T}.

### Results:

Cells were seeded at ˜20% confluence and reached ˜80% confluence after 7 days of culture. No differences in cell growth rate and cell vitality were observed at any time during the experimental procedure between all treatment groups.

During the supplementation period, cells in all treatment groups were collected every ˜48 hours to measure cellular vitamin E content. The mean intracellular concentration (shown are the 10 μM and 300 μM treatment groups) increased significantly by day 2 reaching a plateau (steady state) at around day 6 of treatment (FIG. 1a). After 7 days incubation in media containing 0, 10, 30, 80 or 300 μM RRR- or all-rac-α-Tac, cultured HepG2 cells were again analyzed for their content in free (hydrolyzed α-tocopheryl acetate) cellular vitamin E. The amount of RRR- and all-rac-α-T was significantly increased in all groups when compared to control cells. Intracellular vitamin E increased relatively to the concentration added to the media reaching a plateau between 80 and 300 μM of supplemented vitamin E acetate (FIG. 1b). There was no significant difference between the intracellular concentrations of RRR-α-T and all-rac-α-T.

Of the 14500 genes represented on the Affymetrix GeneChip U133A, 215 were found to be dose-dependently regulated by RRR-α-T within the applied concentration range. The same number of genes, i.e. 215, was also found to be dose-responsive for all-rac-α-T. Comparison of the two groups of responsive genes showed that both forms of vitamin E modulate the identical set of genes of which 104 were up- and 111 down-regulated in a dose-dependent way.

The biological potencies of RRR-α-T and all-rac-α-T were calculated as EC50 and IC50 of the induction and repression, respectively, of genes showing a dose response. The expression data of the 215 responsive genes was fitted with the standard four parameter model and EC50 and IC50 values were calculated (Table 1). Fibrinogen (a) and chondroitin N-acetyl galactosaminyl transferase-2 (b) are representative members of the up- and down-regulated gene-groups, respectively (FIG. 2).

TABLE 1
Transcriptional induction or repression potencies of RRR- and all-rac-α-
tocopherol expressed in EC50 or IC50, as determined in HepG2.

| Potency | EC50 | | | IC50 | | |
|---|---|---|---|---|---|---|
| Number of genes | 104 | | | 111 | | |
| α-tocopherol | RRR-α-T | all-rac-α-T | both | RRR-α-T | all-rac-α-T | both |
| Mean ± SD (μM) | 18 ± 10.7 | 14 ± 9.1 | 16 ± 10.2 | 6.4 ± 6.8 | 6 ± 4.5 | 6.2 ± 5.7 |

Most of the calculated EC50 (104 genes) and IC50 (111 genes) values were ≦35 μM. Of interest is the difference in distribution observed between the EC50 and IC50 values (FIG. 3). While >98% of the EC50 values were <35 μM with two apparent clusters at ˜30 μM and ˜10 μM and a mean EC50 of 16±10.2 μM (FIG. 3a, Table 1), 87% of the IC50's showed values below 10 μM. Also in this case two apparent clusters appeared at ˜8 μM and ˜2 μM with an overall mean IC50 of 6.2±5.7 μM (FIG. 3b, Table 1). There were no statistically significant differences in EC50 or IC50 values between RRR-α-T and all-rac-α-T.

The biological potency ratios of RRR-α-T to all-rac-α-T were calculated based on the EC50 and IC50 values for each of the 215 genes (Table 2). The calculated 215 biopotency ratios distributed in a narrow range of 5:1 (=5) and 1:5 (=0.2) with more than 90% of the calculated ratios showing values in the range of 2:1 (=2) and 1:2 (=0.5). The overall biopotency factor was defined as the mean of all 215 potency ratios and was 1.05 (FIG. 4 and Table 2).

TABLE 2
Biological potency-ratios of RRR- vs. all-rac-α-tocopherol
as determined in HepG2 cells.

| Potency ratio | EC50_{RRR-α-T}/EC50_{all-rac-α-T} | IC50_{RRR-α-T}/IC50_{all-rac-α-T} | Overall |
|---|---|---|---|
| Number of genes | 104 | 111 | 215 |
| Mean ± SD (μM) | 0.9 ± 0.6 | 1.2 ± 0.7 | 1.05 ± 0.7 |

As expected, intracellular vitamin E concentrations did not differ between the two treatment groups (FIG. 1). Analyses of the gene-transcriptional activity of natural and synthetic α-tocopherol revealed that 215 genes (104 up- and 111 down-regulated) were modulated by both “forms” (RRR and all-rac) in a dose-dependent manner. Importantly, natural and synthetic α-tocopherol were found to regulate the identical set of genes, suggesting that the stereochemistry is not an important factor for their gene regulatory activities (Table 1). This result is in agreement with previous observations made in animal models where it was also shown that the natural and synthetic α-tocopherol possess equal biological activity. In FIG. 2, gene-expression profiles in response to α-tocopheryl acetate treatments are shown for two representative genes. The maximum effect was reached when cells were incubated with 80 μM α-tocopheryl acetate, suggesting that the cellular content of α-tocopherol may have been the limiting factor (FIG. 1). No statistically significant differences between the EC50 or IC50 of natural and synthetic α-tocopheryl acetate were observed.

Based on the measured gene-transcriptional activities, the biological potencies, i.e. EC50 or IC50, for RRR-α-Tac and all-rac-α-Tac, were calculated. The majority of the EC50 and IC50 values were below 35 μM and thus within the physiological concentration range found in human plasma (S. N. Meydani, M. Meydani, J. B. Blumberg, L. S. Leka, M. Pedrosa, R. Diamond, E. J. Schäfer, American Journal of Clinical Nutrition 1998, 68(2), 311-318). The resulting EC50 or IC50 values for RRR-α-Tac and all-rac-α-Tac were then used to calculate the potency ratios (EC50_{RRR-α-T}/EC50_{all-rac-α-T} or IC50_{RRR-α-T}/IC50_{all-rac-α-T}) for each of the 215 affected genes. The overall potency ratio, calculated as the mean of the 215 potency ratios, was 1.05 (Table 2, FIG. 4). This result suggests that the biological potency, based on gene-transcriptional activity, is equal for natural and synthetic α-tocopherol.

### EXAMPLE 2

### Experimental Design to Characterize and Compare Chiral Compounds in Animals

Two groups of 25 rats will be randomly assigned to either a diet containing RRR-α-tocopherol or a diet containing all-rac-α-tocopherol (GRRR and Gall-rac). The two groups will be further randomized into 5 subgroups (GRRR1-5 and Gall-rac1-5) containing 5 animals each and will be supplemented as following for a period of 3 months;

GRRR1=0 mg RRR-α-tocopherol/kg diet

GRRR2=5 mg RRR-α-tocopherol/kg diet

GRRR3=20 mg RRR-α-tocopherol/kg diet

GRRR4=70 mg RRR-α-tocopherol/kg diet

GRRR5=300 mg RRR-α-tocopherol/kg diet and

Gall-rac1=0 mg all-rac-α-tocopherol/kg diet

Gall-rac2=5 mg all-rac-α-tocopherol/kg diet

Gall-rac3=20 mg all-rac-α-tocopherol/kg diet

Gall-rac4=70 mg all-rac-α-tocopherol/kg diet

Gall-rac5=300 mg all-rac-α-tocopherol/kg diet

Animals will be sacrificed, tissues of interest isolated (e.g. the liver) and mRNA extracted by standard techniques. High-density oligonucleotides microarrays will be used to assess the dose-dependent transcriptional response to RRR- or all-rac-α-tocopherol, respectively.

The following data calculation and analysis will be carried out as described in example 1. That means genes found to be regulated by RRR-α-tocopherol will be compared with those found to be regulated by all-rac-α-tocopherol. This comparison will give information about possible differences in the biological activity/function between the two forms of α-tocopherol. Subsequently, all genes transcriptional data will be fitted using a “standard four parameters model” and EC50 or IC50 (dose or concentration of a compound that produces 50% of the maximal possible effect) will be calculated. These values will provide important information about the biological potencies of the two compounds.

Subsequently the EC50 of RRR- will be divided by the corresponding EC50 values of all-rac-α-tocopherol and a biopotency factor/ratio will be calculated.

1. A method for calculating the biological activity of a biologically active compound and a counterpart thereof, comprising the steps of:
culturing a plurality of cells in a culture medium and treating the cells with different concentrations of either said compound or said counterpart thereof; or treating a plurality of animals or plants with different concentrations of either said compound or said counterpart;
preparing samples from the treated cells or animals or plants containing a pool of target nucleic acids comprising RNA transcripts;
detecting the expression of genes in said cells by measuring the amount of transcripts of said genes to obtain a target expression pattern by hybridizing said pool of target nucleic acids to an array of nucleic acid probes immobilized on a surface, wherein said array comprising at least 10 different nucleic acids, some of which comprise control probes, and wherein each different nucleic acid is localized in a known location of said surface;
quantifying the hybridization of said nucleic acids to said array by comparing binding of matched and control probes;
calculating the biological activity of the compound and its counterpart therefrom.

2. The method of claim 1, wherein as biological activity the biopotency is calculated.

3. The method of claim 1, wherein the biologically active compound is selected from the group consisting of: (R)-enantiomers, cis-isomers, Z-isomers, endo-isomers, (−)-atropisomers, regioisomers with a functional group in x-position, compounds A, compounds embedded in matrix C, and, in the case of compounds possessing more than one stereocenter, single specific stereoisomers, and the counterpart is selected from the group consisting of: (S)-enantiomers, trans-isomers, E-isomers, exo-isomers, (+)-atropisomers, regioisomers with the same functional group in y-position, compounds B being homologous to compounds A, compounds embedded in matrix D, and, in the case of compounds possessing more than one stereocenter, epimers (e.g. anomers) or diastereoisomers of the single specific stereoisomer, or vice versa, or the biologically active compound and its counterpart being selected from a pair of compounds having the opposite helical chirality.

4. The method of claim 1, wherein the biological active compound and the counterpart are stereoisomers or wherein the biologically active compound is a pure substance with a certain defined stereochemistry whereby the counterpart is a mixture of stereoisomers of this pure substance.

5. The method of claim 4, wherein the biologically active compound is natural vitamin E (RRR-α-tocopherol) and the counterpart is synthetic vitamin E (all-rac-α-tocopherol).

6. The method of claim 1, wherein the counterpart of the biologically active compound is a compound which differs from the biologically active compound in chemical structure and class or is a mixture or composition containing such a compound, wherein the counterpart is used for similar or equal indications in human or animal nutrition and health as the biologically active compound.

7. The method of claim 1, wherein said quantifying step comprises calculating the difference in hybridization signal intensity between each of said nucleic acid probes and its corresponding control probe.

8. The method of claim 1, wherein expression of said genes is detected by measuring the relative and/or absolute amount of transcripts of said genes.

9. The method of claim 1, wherein said amount of transcripts is detected with a high density nucleic acid array.

10. The method of claim 1, wherein said pool of target nucleic acids is a pool of RNAs.

11. The method of claim 1, wherein said pool of target nucleic acids is a pool of RNAs in vitro transcribed.

12. The method of claim 1, wherein the pool of nucleic acid probes comprises at least 100 target nucleic acids.

13. The method of claim 1, wherein the pool of nucleic acid probes comprises at least 1000 target nucleic acids.

14. The method of claim 1, wherein the pool of nucleic acid probes comprises at least 10000 target nucleic acids.

15. The method of claim 1, wherein said biological samples are prepared using cells representing different developmental, physiological, pathological or treatment status.
